(19) United States
(12) Patent Application Publication
(10) Pub. No.: US 2003/0033197 A1
(43) Pub. Date: Feb. 13, 2003

(54) Presentation method for advertisement information

(76) Inventors: Takashi Saga, Kanagawa (JP); Tetsuo Nakano, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/924,497

(22) Filed: Aug. 9, 2001

(51) Int. Cl. G06F 17/60

(52) U.S. Cl. 705/14; 725/42

(57) ABSTRACT

A presentation method for advertisement information shown before and after the featured presentation in a movie theater, wherein the advertisement information is transmitted to the movie theater having a second terminal from a server via a telecommunication system. A server is accessed via an electric medium with a first terminal by an advertising client, and advertisement information is input onto the server by the advertising client. The server may be accessed from the second terminal by an exhibitor in order to show the advertisement information stored in the server. By receiving an access signal from the second terminal of the exhibitor, the selected advertisement information is transmitted from a range of advertisement information stored on the server, to the second terminal of the exhibitor.

### BACKGROUND OF THE INVENTION

The present invention pertains to a method for showing advertisement information in movie theaters using a telecommunication system, in particular, a presentation method for advertisement information that allows the providing of the latest information by updating, changing and adding advertisement information almost everyday in real-time. In addition, it relates to a new presentation method that introduces an interactive communication system in which information from the audience regarding the advertisement information can be received.

In the past, movie theaters have shown motion pictures on film using a projector, and prior to the feature presentation, they have shown advertisement information.

This advertisement information was made in such a way that the film for the advertisement information was attached and there was different advertisement information for each movie theater. By loading the film on the projector, a system was structured in which advertisement information started and then the feature presentation or main program was continuously shown. In addition, unlike the feature presentation film, a method in which advertisement information was shown using a slide projector was proposed. In this case, single image information (still images) on a slide were projected and shown to the audience, and by switching slides, multiple image information was provided.

However, this advertisement information from earlier technologies was not necessarily satisfactory for the audience. In other words, this kind of advertisement information sometimes became annoyance in terms of making the audience feel impatient for the feature presentation. The content tended to be boring and leave an extremely low impression, and in reality, the audience was not interested in this advertisement information.

For the advertiser (advertising client) too, these advertising methods were not something for which they have much expectation. The size of audience in movie theaters is relatively small to begin with and therefore, compared to TV advertising, they have had less expectations. In addition, the advertiser has not been able to confirm how large an audience the information was shown to.

In addition, as described above, the advertising film and the feature presentation film had to be attached together. In particular, for locality reasons, different advertising for each movie theater had to be attached. Therefore, sometimes, in reality, problems have existed where the attaching process was neglected and the information was not shown in the designated movie theaters as in the request by (contract with) the advertiser, and old advertisement information was shown in the movie theater.

This problem has existed too even in the case where a slide projector was used. In other words, film and slides required human labor and cost for creation, storage, shipping, etc. In addition, once the films or slides were created, there could be no changes added to them in real time. And in general, they were used for an extremely long period of time. Moreover, damage and deterioration of the film and slides themselves could occur and therefore, showing them to the audience was sometimes improper.

In other words, the advertisement information shown prior to the feature film in a movie theater has not been important for either the audience, or the advertisers, or the movie theaters.

Recently, large scale movie theaters called cinema complexes, where there are multiple screens on single floors have been developed. The development has drastically changed the traditional concept of “movie theaters are just for watching” where people are forced to be in the same position for a long period of time, and create a form of “movie theater where you can watch and feel” by taking advantage of state-of-the-art technology such as ergonomic seats, and visual and audio equipment. It has been another problem that providing the traditional advertisement information in the state-of-the-art movie theater is outdated.

### SUMMARY OF THE INVENTION

The problem to be solved by the present Invention is to provide a new presentation method for advertisement information shown prior to the feature presentation film in movie theaters in a way that is fully satisfactory to everyone, from the audience to the advertisers and the movie theaters.

In order to solve the above-mentioned problem, the presentation method for advertisement information with the present invention has a step such that a server solicits an exhibitor or show proprietor to gain access in order for advertisement information stored in the server to be transmitted, and a step in which by receiving an access signal from the exhibitor, selected advertisement information from a stored range of advertisement information is transmitted to the exhibitor.

Traditional presentation methods for advertisement information in movie theaters have the above-mentioned problems, therefore, they have not been significant for advertisement information. Therefore, the profit making structure of the movie theater has greatly relied upon the popularity of the films shown and the admission fee. In other words, advertisement information itself doesn't have an independent profit making structure.

The object of the present invention is to improve these current conditions. It will provide the advertisement information shown in movie theaters with an independent profit making structure, and at the same time, through an attempt to reduce the expensive admission fee, it will increase the size of audience and the number of movie theaters, and provide a new and innovative business style.

More concretely, the present invention provides a new method such that advertisement information is shown via a computer system using telecommunication technology. Unlike traditional methods that show the same advertisement information for a long period of time, the method of the present invention shows advertisement information that is in real-time, fresh and always attracts the audience.

In addition, with the present invention, the registration, correction, updating, and deletion of advertisement information may be carried out by the advertising client, by accessing the servers owned by the advertising agency, using the telecommunication system. By doing this, advertisement information can be updated in real-time allowing that information meets the audience's needs.

Moreover, with the present invention, advertisement information is shown before and after the feature film presentation. And it may be a digital motion picture that is projected by a projector. Unlike the still images of the slide method, this means that the advertisement information of the present invention is a motion picture and is more attractive for the audience. In addition, because it is a projection of a digital motion picture, compared to the film projection method, a clear and real looking motion image can be shown.

Furthermore, with the present invention, the advertisement information may be in the form of Questions and Answers or a questionnaire. The audience entering the movie theater may have an equipment to transmit their personal opinions about the advertisement information, and this opinion information may be transmitted to the server.

This greatly changes the style of traditional movie theaters because it has an interactive communication means by which the audience expresses their opinion about the advertisement information. In other words, the presentation method for advertisement information of the present invention utilizes telecommunications, and therefore, by taking advantage of the line, in the reverse direction, it can take in the audience's opinions. By doing this, it is possible to have advertising that can adequately reflect the audience's opinions and transform it from a style that is a one-sided means of showing the advertising to the audience. Also, this kind of advertising allows not only for the advertising of products or services but also various surveys by research companies, providing a new and innovative business style to the advertising presentation prior to the feature presentation in movie theaters.

### BRIEF EXPLANATION OF DRAWINGS

FIG. 1 shows the entire structure of the advertising presentation method of the present invention.

FIG. 2 shows an example of an advertisement of the present invention.

FIG. 3 shows another example of an advertisement of the present invention.

FIG. 4 shows another embodiment of the advertising presentation method of the present invention.

FIG. 5 shows the entire structure of the interactive communication system of the advertising presentation method of the present invention.

FIG. 6 shows a flowchart of an embodiment of the interactive communication system of the advertising presentation method of the present invention.

### PREFERRED EMBODIMENTS OF THE INVENTION

Next, embodiments of the presentation method for the advertisement information of the present invention are described. Before doing so, the definitions of the terms used in the present invention are described as follows.

In the presentation method of the advertisement information of the present invention, “Advertisement information” comprises not only the advertising for products and services of an advertising client, but also various questionnaires that seek opinions or the likes or dislikes of the audience, as well as entertaining short stories. In addition, the “Server” is a storage of a range of advertisement information to be shown in movie theaters, and means a large computer telecommunication system owned by advertising agencies, etc. “Movie theater” does not mean a movie theater in the strict sense, and it applies as long as motion pictures are being shown to several audiences. The concept in the present invention may include, for instance, food services, hotels, auditoriums, city halls, civic centers, or even regular homes. Furthermore, “Exhibitors” mean movie theaters, entertainment businesses that manage movie theaters, and agencies who take on the role. “Terminals” are terminals for the advertisers and the terminals that are owned by the entertainment businesses or movie theaters. Both of them imply telecommunication systems utilizing, for example, personal computers.

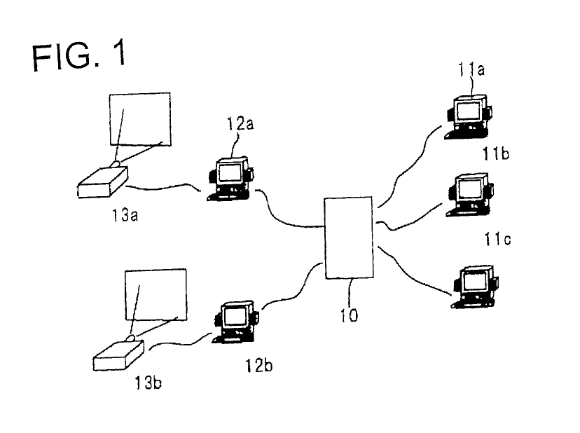

FIG. 1 is a block diagram that shows the entire structure for describing the presentation method for the advertisement information of the present invention. A server 10 stores a large amount of advertisement information, data regarding advertisers, and authorization data for movie theaters as described later. This server 10 may be a large computer owned by, for example, an advertising agency. For example, a QUBIT (TM) may be used, which has a large 299 gigabytes.

First terminals 11 (11a, 11b, 11c . . . ) are connected to the server 10 owned by such as an advertiser as described later. These first terminals 11 are operated in accordance with a method for registering the advertisement information solicited by the server 10.

Second terminals 12 (12a, 12b . . . ) are similarly connected to the server 10 owned by a movie theater (or an exhibitor). These second terminals 12 are also operated in accordance with the method for transmitting advertisement information solicited by the server 10.

The server 10, first terminals 11 and second terminals 12 are connected with each other by telecommunication lines. These telecommunication lines are, for example, telephone lines, digital subscriber lines (ISDN, ADSL, optical fibers), satellite frequency lines, ground frequency lines, cable subscriber lines, etc.

Image display devices 13 (13a, 13b . . . ) are connected to the terminals 12, and are operated by receiving signals from terminals 12. The image display devices 13 may be projection-type LCD projector devices, for example. This LCD projector device is to project images on a screen by controlling the individual pixels on a LCD screen by shielding or projecting light, allowing the projection of digital images with the projecting of advertisement information transmitted from the servers on a screen.

Furthermore, an image display device 13 may not be limited to an LCD projector device. It has the same effect when it is a projector device using a DMD (digital micromirror device TM), or a projector device using D-ILA elements (TM). These image display means 13 and second terminals 12 are provided to movie theaters where advertisement information is shown.

Also, in addition to the second terminals 12 and projector devices 13, the movie theater may own their own servers. As a server, for example, a QUBIT (TM) is used. Accumulating a lot of advertisement information on a server eliminates the trouble of transmitting the advertisement information itself via the telecommunication line for every show, and it is possible to greatly reduce the preparation time for operations. This type of server may be different from one owned by an advertising agency, and for example, should have around 74 gigabytes.

Next, the procedure for the presentation method of advertisement information with this structure is described.

The advertising client completes the connection procedure for a telecommunication line from a first terminal 11 (personal computer) that is personally owned and connected to server 10, which is owned by a designated advertising agency. The connection procedure for the telecommunication line may be carried out through an Internet line. In that case, they connect to a homepage owned by an advertiser. An advertising client may have already completed a set agreement with the advertising agency in advance. The connection (access) is allowed by inputting authorization data provided by the advertising agency, such as passwords. The first time that the advertising client accesses the advertising agency, it is necessary to register data that designates the advertising client such as name, address, telephone number and credit card number, similar to an application over a normal telecommunication line, and complete a set agreement with the advertising agency. On the server owned by the advertising agency, this kind of personal data from the advertising client is stored in the requester's data file and is associated by the authorization data such as a password.

The advertising client completes the connection to server 10 owned by the advertising agency by inputting this kind of authorization data. And then follows the following procedure.

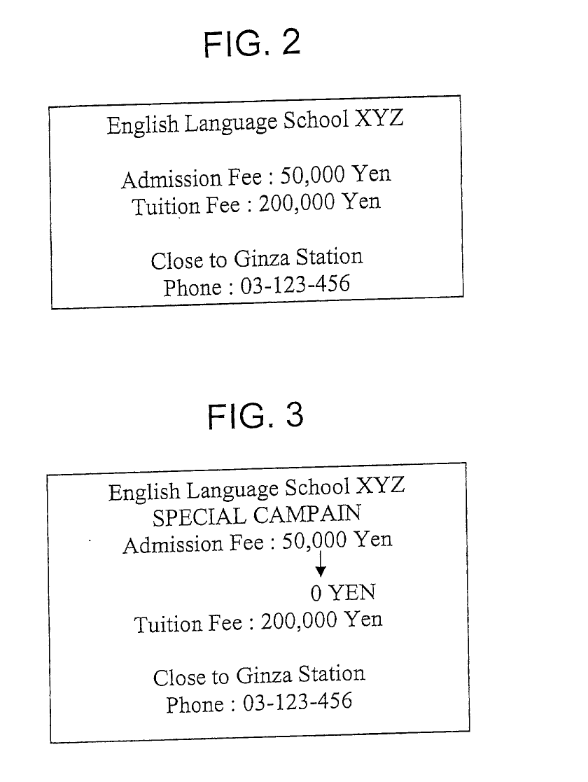

In other words, when advertisement information is newly provided, the advertisement information is transmitted. For example, as shown in FIG. 2 as a concrete example, if the advertising client is an English conversation school, the advertisement information shown in FIG. 2 is transmitted using the terminal owned by themselves, via the telecommunication line.

Then the server that received the above-mentioned advertisement information associates it with the personal information stored in the requester's data file using the transmitted authorization data, and then stores it in the advertisement information file.

In this case, additional information can be added to the advertisement information. For example, when the advertising client desires to show it in movie theaters in a designated area, or show certain content, or for instance, when they desire to show the advertisement information before and after only a certain movie showing such as an animation for children, or an educational movie for students, or to limit the showing period, this kind of additional information can be added to the information and stored on the server. In this case, the information is stored in an additional information file on the server by associating it with the advertisement information and personal data.

Here, the request for the advertisement information from the advertising client is not limited to the use of the telecommunication system. It is acceptable for video tapes, floppy disks, and the original artwork for the advertising to be provided directly or through means such as mail. However, when the method of providing the advertisement information from the advertising client uses the telecommunication system described as above, then changes in content are easily carried out in real-time and it is, needless to say, superior.

Next, is the case that the advertising client wants to correct already registered advertisement information on the server.

The advertising client completes the connection with the server owned by the advertising agency by inputting authorization data as described above. Then, the previously corrected advertisement information is transmitted again from the terminal device (personal computers) owned by themselves to the server. In this case, by transmitting a new update command to replace already registered advertisement information, the advertisement information stored on the server can be refreshed.

A concrete example of the above is, for instance, in the case that the advertising client is the English conversation school, and by completing the renewal procedure, for example, new advertisement information can be provided as shown in FIG. 3.

These updates and additions of advertisement information allow advertisement information in theaters to be real-time as described later. Unlike traditional advertisement information, the same information will not be continuously shown for a long period of time, and as a result, it solves the problem of the audience becoming bored.

Next, the access method for movie theaters (exhibitors) to the advertisement information is described. The movie theaters complete a set connection procedure for the telecommunication line from the second terminal 12 (personal computer) owned by themselves, and then connect to server 10 owned by the advertising agency. The connection procedure for the telecommunication line may be carried out through an Internet line. In that case, they connect to the homepage owned by the advertiser. The movie theater has already completed a set agreement with the advertising agency in advance. The connection (access) is allowed by inputting authorization data provided by the advertising agency, such as passwords. The first time that the movie theater accesses the advertising agency, it is necessary to register data that designates the movie theater such as the name of the movie theater, and the address, and the name, address and telephone number of the management representative, just like an application over a normal telecommunication line, and the movie theater completes a set agreement with the advertising agency.

On server 10 owned by the advertising agency, this kind of data specific to the movie theater is stored in the movie theater data file and is associated with the authorization data such as a password. In this description, the expression “the movie theater accesses” is used for convenience, however, it is obvious that in a strict sense, it is accessed by an employee of the movie theater.

The movie theater completes the connection with the server owned by the advertising agency by inputting this kind of authorization data, etc., and follows the following procedure.

In other words, the movie theater selects the advertisement information that is appropriate for the movie shown for the day, and by transmitting the command for the advertisement information, the selected advertisement information is sent from server 10 to the second terminal 12 owned by the movie theater. By referring to the additional information, the selection of the advertisement information is facilitated.

Then the movie theater can show, for example, the advertisement information as shown in the FIG. 2, prior to the feature presentation. This advertisement information is not only still pictures as in the prior art, but also it is possible to show motion pictures, and in particular digital images. In addition, by using it with high precision sound facilities, it can fully satisfy the audience.

For the embodiment described above, the case in which the selection of the advertisement information by the movie theater is carried out arbitrarily, by taking the movies being shown for the day and the date of presentation into account, is explained. However, for the advertising shown, it is acceptable, for example, that the presentation of a certain advertisement is required under certain conditions, such as when a certain movie is shown or on a certain date of presentation, through an agreement between the advertising client and the movie theater, or an agreement with the advertising agency. This kind of requirement can be easily carried out by linking a process by which designated advertisement information is transmitted to the terminal of the movie theater from server 10 in advance upon access by the movie theater to server 10.

This method of providing advertisement information is as satisfying to the audience as the feature film. If it is not satisfactory, the content can be updated immediately. In addition, the advertising client can expect a lot from the advertising, and therefore, a large profit can be expected from the financial benefits of the advertising.

In addition, unlike a traditional slide-style projector or projectors using film, it is not necessary for an advertising film to be created individually by the movie theaters. Therefore, the problem of management, shipping and damages for the movie theater can be solved.

The servers of the advertising agency exist in a set location such as where the advertising agency is located, however, the movie theaters connecting to the server can be anywhere in Japan or even abroad, allowing the showing of advertisement information to be updated in real-time in remote movie theaters.

When a movie theater owns their own server, only when they are storing new information or updating existing information, can they access the main server owned by the advertising agency. In other words, unnecessary operations wherein they have to access the main server even though the desired advertisement information has not been updated can be eliminated.

Here, for access by the exhibitors to the server, there is a step in which the server requests access from the exhibitors. It can be, for example, a number of statements by the advertising agency owning the server that indicate an input screen or input location for inputting authorization data such as a password, on, for example, a homepage or other initial telecommunication screen. From this kind of input screen, the exhibitors (movie theaters) input the authorization data such as a password and then it is possible to connect to the server.

This is not limited to the access between the exhibitors and the server, and it is the same for the server and the advertising client.

The embodiment above is described in the case in which the movie theater side, namely the manager and employees of the movie theater actively obtain advertisement information and show it in the movie theaters they manage. Next, another embodiment is explained.

Another case is when there is an exhibitor who manages and supervises multiple movie theaters, and this exhibitor accesses the advertising agency and obtains and updates advertisement information and at the same time transmits orders to each movie theater so that they show the selection of advertisement information. In this case, from the movie theater's point of view, advertisement information transmitted from the exhibitors is passively presented.

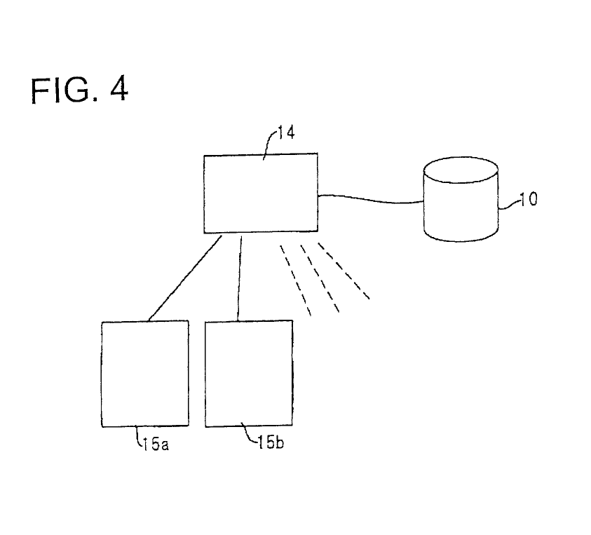

FIG. 4 shows the embodiment described above.

A show prprieter 14 completes the registration with the advertising agency to receive the above-described advertisement information and then accesses server 10 of the advertising agency using the designated authorization data, as described above.

The show proprieter 14 transmits advertisement information to multiple movie theaters 15 (15a, 15b . . . ) that it manages and supervises. In this case, the exhibitor 14 takes the locality and time into account and transmits the selected advertisement information.

As described above, if each of the movie theaters 15 has its own server, the advertisement information itself can be transmitted only when there are changes in information such as updating, and therefore sending an order for which information is to be shown of the stored advertisement information on their own server is sufficient. In addition, this kind of embodiment is especially effective during a movie presentation at a cinema complex.

A cinema complex is, as described above, a multiple large-scale movie theaters wherein multiple movie theaters are on a single floor. Recently, ones have evolved having theaters of different sizes so that movies can be efficiently shown by taking the expected size of the audience into account.

At this kind of cinema complex, the exhibitor can give orders to show different advertisement information for each of the multiple theaters on the floor, so that advertising can be shown by taking the movie, audience, and the time of the presentation into account. There are many names for cinema complexes, and in the present invention, a multiplex, a cinemaplex, and a megaplex are considered as cinema complexes.

Next, another embodiment of the advertisement information presentation of the present invention is described.

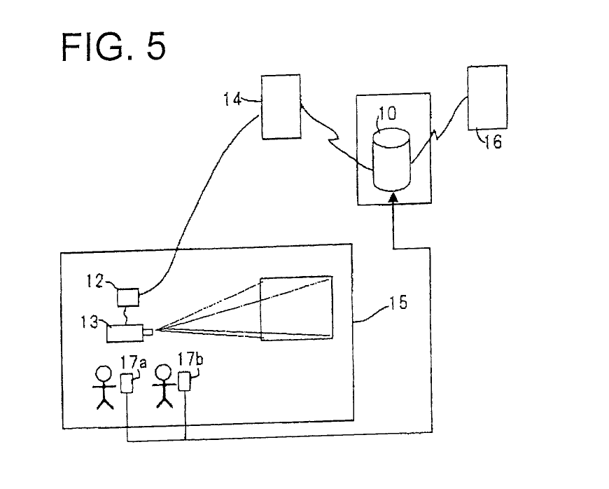

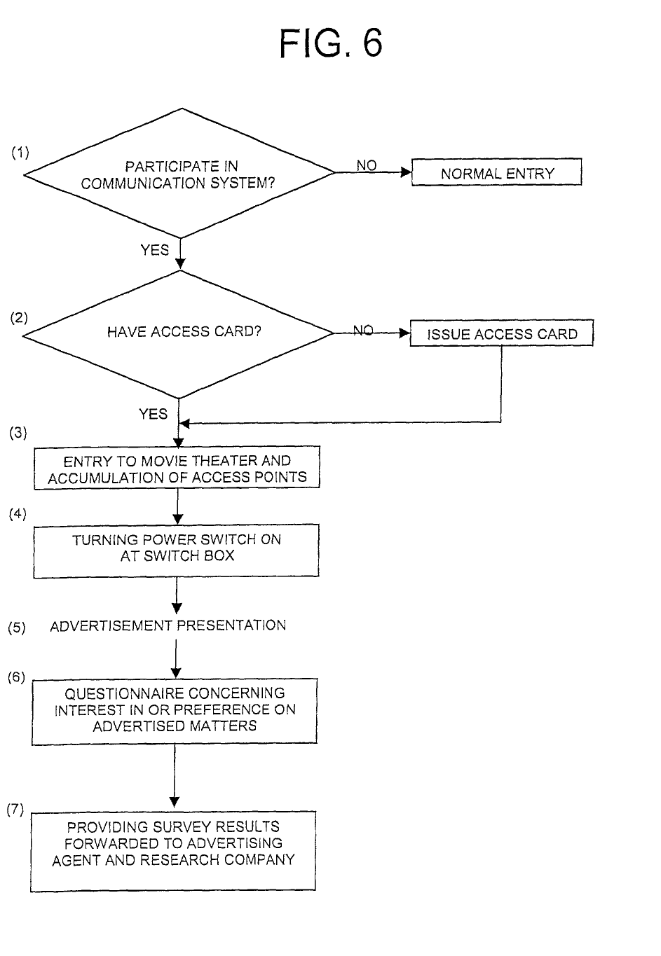

FIG. 5 shows an embodiment that proposes a new style of movie theater and a method of providing advertisement information that allows interactive communication such that the audience that enters the movie theater is now not only viewing the advertisement information but also an individual in the audience can transmit his or her opinion.

With the present invention, the advertisement information is shown prior to the feature presentation. The presentation method is, as shown above, a new method of distribution with transmission through a computer system and telecommunication lines. Therefore, by taking advantage of the computer system and telecommunication lines, it is possible to send the audience's opinions from the movie theater side to the server of the advertising agency, and furthermore, the advertising client.

A research company 16, which is a type of advertising client, registers the content to be surveyed onto the main server 10 of an advertising agency. The content to be surveyed can be a variety of items, for example, research on likes and dislikes or a questionnaire regarding the news.

Here the registration method for the information by the research company 16 is the same as the request for advertisement information by the advertising client, and they access using authorization data, etc.

When the content to be surveyed by the research company is stored on server 10, the exhibitor 14 accesses and decides to show the survey information in the movie theater.

Movie theater 15, which receives a research signal from an exhibitor 14, shows the survey information as advertisement information using a terminal 12 and a projector 13 prior to the feature presentation.

Here, the audiences who saw the survey information, for example, have switch boxes 17 (17a, 17b . . . ) installed at their seat, etc., and using a yes/no function or the number selection function of the switch boxes 17, provide their personal opinions.

For instance, research such as which model gives a favorable impression to the audience from four models of new cars, can be obtained through this method. In this case, of course, it is not just a mere still image, but a motion picture that is shown of the driving conditions and the features of the new car in a real way, and the audience can fully experience this information allowing them to make a selection of the model based on real information. A volume gauge that measures the magnitude of the audience emotion can be employed as well. In this case, not only a mere opinion about which model the audience is interested in, but also the magnitude of the interest can be expressed by the volume.

These kinds of survey results are immediately transmitted to the main server of the advertising agency, and the results are returned to research company 16.

Needless to say it can be accompanied with a variety of services such as the distribution of promotional gifts to the audience. In addition, as described later, by registering data that shows the demographics of the audience such as sex, age and occupation, in advance at the movie theater, it is possible to obtain the survey results, for instance in the case of a new car model selection as described above, and the interest breakdown by age or sex. Furthermore, in order to utilize the audience data more deeply, it is possible to mail gifts, or a magazine that shows information on new cars by the research company via the car distributor, by having the audience register their names, addresses, telephone numbers, etc.

The research company 16 can, naturally, tell how many of the audience have participated in the survey. This is not limited to the survey, but is the same for the advertisement information provided by the advertising client. The advertising client can understand how many in the audience were provided with the advertisement information. This point is significantly different from the advertisement information in the traditional movie theater.

Here, embodiments of the advertisement information presentation method using the above-mentioned interactive communication are described.

(1) First, when an audience member is entering the movie theater, the audience member is asked whether he or she would like to participate in the communication with a system in the movie theater prior to the feature presentation or not.

When they answer is negative, the audience member enters the movie theater just as a normal guest.

(2) When the answer is positive, the audience member is asked whether he or she has an access card or not. When the audience member already has the access card, the access card is swiped and information recorded is read by a card reader. When the access card is not available, then the procedure to issue an access card is carried out. During this procedure, personal information of the audience such as name, address, telephone number, age, occupation, sex, height, weight, hobbies, credit card number and bank account numbers is recorded and stored.

(3) The audience member who presents the access card enters into the theater for the admission fee. At the time, the movie theater assigns a seat for the audience member. The admission fee payment may be made by cash but not limited to. It may be made by means of a credit card. The audience member may receive some gift or treatment, such as accumulation of access points, which would result in awards at a later time based on the accumulation.

(4) At a designated seat, the audience member may use a switch box. By turning the power on, the audience member participates in the communication. The other audience member who has rejected the participation in (1) would sit at a seat with a switch box disabled or a seat without a switch box.

(5) Next, the advertisement information presentation starts prior to the feature presentation. This presentation may continue for approximately 20 minutes and may include previews of coming attractions. The presentation of the advertisement information may be from still image to high quality image from motion pictures similar to a household TV.

(6) After the advertisement information, such as commercial film presentation for a new product, is shown, a questionnaire including a question such as “[d]o you want to purchase this product now?” may be displayed on the screen to know whether the audience has liked, preferred or has been interested in the product. In response to the question, the audience member makes an answer using the nearby switch. By presenting the questionnaire, an interactive communication in which the audience members themselves interact with the advertisement information can be achieved.

(7) The result of the survey is immediately fed back to the advertising agency or research company. The research company may present the same question in the next presentation of the advertisement information after the feature presentation (2 to 3 hours later), or a new questionnaire can be created based on the results and shown.

With the presentation of the advertisement information, the audience can receive additional rewards or treatments such as receiving a gift by accumulating access points through presenting the access card, or a discount on the admission fee. Also they can receive services such as getting an expensive gift or a small gift through a sweepstakes after answering questions. At the lobby of the movie theater, it is possible to actually sell the products and services in the presentations, and it is possible that the sales performance can be transmitted to the research company in real-time. For example, information on newly registered people and advertisement information for the movie theater can be immediately reported. Through this method, a further increase in subscribers can be expected.

In addition, when the access card is read by the card reader upon entering the movie theater, registration data taken at the time of access card issuance can be displayed at the entrance. For example, by displaying the age, sex, height and weight, the guest can be identified allowing the prevention of illegal use of the access card to enter the movie theater by a third party. As described above, a variety of survey results can be analyzed by associating the registration information from the access card and the information from the answers to the survey, and therefore, it is an extremely effective means to increase the reliability of the survey results.

Moreover, in order to make this association be more precise, it is possible to use biometric individual ID information derived from such as fingerprints or cornea can be used. In this case, it requires a process to present the ID information upon the registration of the access card and at the presentation of the access card when entering the movie theater.

In the embodiment described above, in the case where communication is carried out using a switch that is installed in a switch box at a reserved seat, the switch box does not necessarily need to be installed at all the seats, so that by taking into account the people who are not participating in the communication in advance, it is acceptable for the switch box to be installed at a portion of the seats.

Furthermore, the switch box can be a portable type with a remote control unit. In this case, each switch can be associated with the user by delivering it at the reception area and associating it with the entering audience or by carrying out the authorization process such as reading the access card for the switch at the seat. By doing so, the construction for the installation of a switch box at the seat, can be eliminated, as well as making it is possible to eliminate the enforced assignment of a seat to the audience member.

These various services make the audience think that the advertisement information prior to the feature presentation is not mere images for fill in, but rather they make the audience as strongly interested in the service as they are in the featured presentation. Consequently, for the advertiser and the movie theater, it provides a new business style in which independent profits can be made in contrast to a profit structure that has been dominated by the content of the featured film and the admission fees.

In addition, beyond showing the advertisement information on the screen in the theater, similar advertisement information can be shown in the lobby as well. Namely, the advertising of the present invention attracts the audience's interest, and therefore, the audience is attracted to the advertising more than the feature presentation. In this case, the problem of waiting for the next presentation can be resolved.

Moreover, interactive communication may be advertising with a story that depends on the answers of the audience. More concretely, it can be a short story that includes questions to the audience during scenes and the story develops along a selected path from prepared stories depending on the answers. By adding entertaining features in which the advertisement information changes based on the selected answers of the audience, the interest of the audience in the advertising is even further enhanced. In particular, the story development in this case is, for example, decided by majority rule, so that even if the same audience participates again, the advertising content can change. In terms of this, it has a great draw on the audience's interest.

As described above, the advertisement information presentation method of the present invention is:

First, a high-quality digital motion picture of the advertisement information from the advertising client can be provided in real-time, by accessing a server from the movie theater.

Therefore, unlike the advertisement information of traditional still images, the audience will not be bored and it is possible to make the advertising interesting. In addition, the advertisement information is provided via a telecommunication system, and therefore, the client can update the content in real-time, allowing them to expect more from the advertisement information. In addition, for movie theaters, there are great advantages in terms of operation, management, storage and shipping.

Secondly, an exhibitor can transmit the advertisement information to their subsidiary movie theaters, and show the advertisement information received at the movie theater using a projector in accordance with the order given by the exhibitor, and therefore, for example, at a cinema complex, by taking into account the popularity of the movies and the audience types, the advertisement information in multiple theaters can be controlled centrally, in real time.

Third, by having a system in which the advertisement information can be made into a Question and Answer style, and through communication with the audience entering the movie theater, there will be a further increase in the interest of the audience in the advertising. For the advertising client and research companies, business activities reflecting the audience's opinion can be taken.

The disclosure of Japanese Patent Application No. 2000-240680 filed Aug. 9, 2000 including specification, drawings and claims are herein incorporated by reference in its entirety.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. A presentation method for providing advertisement information stored in a server to an exhibitor via computer telecommunication system, before showing the advertisement information to an audience, comprising steps of:
soliciting an exhibiter from a server to access the advertisement information stored in the server;
selecting advertisement information among information stored in the server;
forwarding advertisement information from the server to the show exhibitor based on the access by the exhibitor to the server.

2. A presentation method for advertisement in accordance with claim 1, wherein said method further comprising a step of:
soliciting an advertising client to access the server via an electronic medium and to input advertisement information to the server.

3. A presentation method for advertisement in accordance with claim 1, wherein the advertisement information is shown before or after a feature presentation.

4. A presentation method for advertisement in accordance with claim 2, wherein contents of the advertisement information is changed in real-time by the advertising client.

5. A presentation method for advertisement in accordance with claim 1, wherein the advertisement information forwarded to the exhibitor is transmitted to a movie theater where the advertisement information is shown to the audience.

6. A presentation method for advertisement in accordance with claim 1 wherein, the advertisement information is a questionnaire, and a response to the questionnaire by the audience is transferred to the server.

7. A presentation method for advertisement in accordance with claim 6, wherein personal information of the audience is registered and the personal information associated with the response is transferred to the server.

8. A presentation method for advertisement in accordance with claim 1, wherein the advertisement information is shown as a digital motion picture projected from a projector.
